(19) United States
(12) Patent Application Publication
(10) Pub. No.: US 2005/0263136 A1
(43) Pub. Date: Dec. 1, 2005

(54) Fuel delivery system

(76) Inventor: Shaun Thomas Rigney, Victoria (AU)

Correspondence Address: KENNETH M. FAGIN, 136 SUMMER WALK DRIVE, GAITHERSBURG, MD, 20878, US

(21) Appl. No.: 10/527,154

(22) PCT Filed: Sep. 5, 2003
(86) PCT No.: PCT/AU03/01156

§ 371 Date: Mar. 9, 2005

(30) Foreign Application Priority Data
Sep. 11, 2002 (AU) 2002951332
Aug. 1, 2003 (AU) 2003904065

(51) Int. Cl. F02M 31/04; F02M 31/12

(52) U.S. Cl. 123/470; 123/543; 123/549

(57) ABSTRACT

A fuel delivery system for an IC engine includes an injector (240) which is heated as its region to elevate the temperature of the fuel in the end region and so that when the fuel is ejected from the end region, it immediately converts to vapour. Heating of the end region is performed either by direct conduction from the engine or by an electrical heating element. A gasket (22) of heat conducting material is provided between the cylinder head and the inlet manifold (200) so heat is conducted to the inlet manifold (200) and then to injector (240). An electrical heating element (320, 380) is provided surrounding the end region of the injector so that it can heat up the end region immediately without having to wait for the engine to reach operating temperature.

### FIELD OF THE INVENTION

This invention relates to a fuel delivery system and, in particular, to an improvement to the system disclosed in our International Application No. PCT/AU02/00403.

The contents of the above International application are incorporated into this specification by this reference.

### BACKGROUND ART

Our above-mentioned International application discloses a fuel injection system which heats the end region of a fuel injector so as to elevate the temperature of the fuel in the end region. This results in the fuel converting immediately to vapour when the fuel is ejected from the end region of the injector into an air inlet port of an engine. Thus, as soon as the fuel leaves the injector, the fuel immediately converts to vapour state because of the heating of the fuel in the end region and the change in pressure experienced by the fuel when the fuel leaves the injector. Therefore, the fuel is delivered to the cylinder in vapour form which greatly decreases fuel consumption.

In our aforementioned International application, a number of different ways of heating the end region of the injector are disclosed. One form utilises direct conduction of heat from the engine to the end of the fuel injector.

In the normal configuration of modern engines, inlet ports of the head of the engine are insulated to some degree from the inlet manifold to prevent heat transfer from the head to the manifold to keep the inlet manifold as cool as possible. This, combined with the use of seals on the end region of the injector, prevents any heating of the fuel in the injector end region.

### SUMMARY OF THE INVENTION

The object of a first aspect of the present invention is to improve the direct conduction heating of the injector of the type disclosed in the aforementioned International application.

The present invention may be said to reside in a fuel delivery system for a vehicle engine, having at least one cylinder, a piston moveable in the cylinder, and an inlet port for supplying air and fuel to the cylinder, comprising:
an inlet manifold for supplying air to the inlet port;
a heat conducting gasket between the engine and the inlet manifold;
an injector port in the inlet manifold;
a fuel injector having an end region and a body, the body including componentry for operating the injector, the injector being located in the injector port; and
wherein heat is conducted from the engine via the heat conducting gasket to the inlet manifold, and then to the end region to heat the end region, but not the body of the injector, to elevate the temperature of fuel in the end region, so that when the fuel is ejected from the end region of the injector, the fuel substantially immediately converts to vapour because of the heating of the end region and therefore the fuel in the end region, and the change in pressure experienced by the fuel as the fuel leaves the end region of the injector.

The use of a heat conducting gasket and heat conduction from the gasket to the manifold and then to the heat conducting end region ensures good heat transfer to the end region to elevate the fuel to the required temperature to ensure that the fuel immediately converts to vapour when the fuel is ejected from the injector.

In one embodiment of the invention, a heat conducting collar is provided around the end region of the injector and in heat conducting contact with the end region, and the collar being in the heat conducting contact with a wall defining the injector port.

In another embodiment, the injector port is sized such that the end region of the injector is in direct heat conducting contact with a wall defining the injector port.

Preferably the gasket includes opposed sides, and at least one opening for providing communication from the inlet manifold to the inlet port, a first raised section surrounding the opening on one side of the gasket, and a second raised section surrounding the opening on the other side of the gasket, so that when the gasket is located between the engine and the inlet manifold, and the inlet manifold secured to the engine, the raised sections deform to form a seal about the opening.

Preferably the gasket is formed in a stamping or pressing operation, and the raised section is formed by a V-shaped projection in transverse cross-section on one side of the gasket, and an offset V-shaped projection in transverse cross-section on the other side of the gasket.

In one embodiment of the invention, a housing is provided for locating over the injector and the injector port to facilitate the retention of heat to heat the end region of the injector.

In one embodiment of the invention, electrical heating means is provided for supplying heat to the end region during initial start-up of the engine before the engine acquires sufficient heat for conduction to the end region to heat the end region, and therefore the fuel in the end region by heat conducted from the engine.

In one embodiment the electrical heating means comprises an electrical heating pad in electrical contact with the end region, an insulating member between the pad and the engine, and an electrical inductor in electrical communication with the pad so that current is supplied to the pad and then flows through the end region to heat the end region.

In another embodiment the electrical heating means comprises a coil wound around the end region, electric leads for supplying current to the coil so that the passage of current through the coil generates heat to the heat the end region.

This embodiment of the invention may include temperature sensing means for monitoring the temperature of the engine in the vicinity of the fuel injector for switching off the electrical heating means when the engine temperature reaches a predetermined temperature whereby sufficient heat is conducted from the engine to the end region to heat the fuel in the end region.

A second aspect of the invention is concerned with supplying sufficient heat to the end region of the injector during initial engine start-up so that as soon as possible after engine start-up, fuel in the end region of the injector is elevated to the required temperature to substantially immediately convert to vapour as soon as the fuel is ejected from the injector.

This aspect of the invention may be said to reside in a fuel delivery system for a vehicle engine, having at least one cylinder, a piston moveable in the cylinder, and an air port for supplying air and fuel to the cylinder, comprising:
an inlet manifold for supplying air to the inlet port;
an injector port;
a fuel injector located in the injector port, the fuel injector having an end region and a body, the body including componentry for operating the injector; and
electrical heating means for heating the end region, but not the body of the fuel injector, to elevate the temperature of the fuel in the end region, so that when the fuel is ejected from the end region of the injector, the fuel substantially immediately converts to vapour because of the heating of the end region, and therefore the fuel in the end region, and the change in pressure experienced by the fuel as the fuel leaves the end region of the injector.

The use of the electrical heating means enables heat to be supplied immediately the engine is switched on and does not require the engine to heat up before sufficient heat is supplied. The time taken for an engine to heat to the required temperature so that the conduction of heat to the injector to heat the injector in the first aspect of the invention may be up to 200-300 seconds. Whilst this time period is not significant if the engine runs continuously it nevertheless does play some part in the overall fuel consumption of the engine. Obviously, if the engine is switched on and off regularly and cools between restarts, then the start-up period of 200-300 seconds before the engine reaches the required operating temperature is more significant. The electrical heating means of this aspect of the invention enables heat to be conducted to the end region of the injector much more quickly, which further improves fuel consumption, particularly in the initial period after engine start-up, and until the engine reaches the required operating temperature. This aspect of the invention may therefore be used primarily in the first 200-300 seconds or thereabouts after initial start-up, after which time, heat conducted from the engine can supply the heat to the end region, or, alternatively, could be used as the sole or primary source of heat to the end region to heat the end region to the required temperature to cause the vaporisation of the fuel immediately the fuel leaves the injector.

In one embodiment of the invention electrical heating means is arranged on the outer surface of the end region.

In one embodiment the electrical heating means comprises an electrical heating pad in electrical contact with the end region, an insulating member between the pad and the engine, and an insulated electrical conductor in electrical communication with the pad so that current is supplied to the pad and then flows through the end region to heat the end region.

In another embodiment the electrical heating means comprises an insulated heating coil wound around the end region, and electrical conductors for supplying current to the coil so that the passage of current through the coil generates heat to heat the end region.

In one embodiment temperature sensing means is provided for sensing engine temperature and for switching off supply of current to the electrical heating means when the engine temperature reaches a predetermined temperature sufficient to heat the end region of the conductor to the required temperature to cause the fuel to vaporise substantially immediately upon ejection from the injector.

This aspect of the invention further provides a fuel injector for an internal combustion engine having a piston moveable in a cylinder, the injector comprising:
an end region;
a body;
electrical componentry in the body operable to enable fuel to be ejected from the end region of the injector; and
electrical heating means on the external surface of the end region for heating the end region of the injector, but not the body, so that when fuel is located in the injector and the electrical heating means operated, the fuel is ejected from the end region of the injector and substantially immediately converts to vapour because of the heating of the end region and therefore the fuel in the end region, and the change in pressure experienced by the fuel as the fuel leaves the end region of the injector.

In one embodiment the electrical heating means comprises an electrical heating pad in electrical contact with the end region, an insulating member between the pad and the engine, and an insulated electrical conductor in electrical communication with the pad so that current is supplied to the pad and then flows through the end region to heat the end region.

In another embodiment the electrical heating means comprises an insulated heating coil wound around the end region, and electrical conductors for supplying current to the coil so that the passage of current through the coil generates heat to heat the end region.

The invention may be said to reside in a fuel delivery system for an engine which has a combustion chamber, a piston movable in the combustion chamber, an air inlet port and an exhaust port, comprising:
an injector port in the engine having a first open end communicating with the combustion chamber, and a second end remote from the first end, the injector port having an injector port wall;
a fuel injector located in the injector port, the fuel injector having an injector main body which houses electrical components for operating of the injector, an injection tip and an end region adjacent the tip, the end region being for storing fuel to be ejected from the injector;
an electrical heating element surrounding the end region exterior of the fuel injector; and
an electric current supply for supplying current to the heating element for heating the end region of the injector to in turn heat the fuel in the end region so that when the fuel leaves the injector, the fuel substantially immediately converts to vapor because of the heating of the fuel and the change in pressure experienced by the fuel when the fuel leaves the injector.

Thus, because the heating of the injector is performed by electric current, it is not necessary for the engine to reach operating temperature before the system will operate adequately. Thus, the heating element can be activated immediately the engine is turned on so that the injector end region is heated substantially immediately and the system operates to heat the fuel much quicker than is the case if engine temperature or exhaust gas temperature is used to heat the end region.

Preferably, the heating element is provided in a cylindrical sleeve which locates over the end region of the injector, and sits between the end region of the injector and the injector port wall of the injector port in the engine.

Preferably, the current supply comprises at least one conductor extending from the heating element to a current supply device.

Preferably, the current supply device comprises a battery for supplying current and a pulse width modulator for modulating the current supplied by the battery so that the current supplied to the heating element is pulsed width modulated so that the amount of current supplied to the heating element can be controlled to thereby control the heating of the heating element, and therefore the heating of the fuel within the injector end region.

Preferably, the current supply includes a relay so that current is supplied when the relay is closed, and a control current supply for closing the relay.

Preferably, the control current supply comprises a signal from a fuel pump relay which passes through an engine temperature sensor so that if the engine temperature is below a predetermined temperature, the relay is closed to thereby enable current to be supplied to the heating element.

Preferably the fuel injector includes a temperature sensor for monitoring the temperature of the fuel in the end region and for opening the relay when the temperature reaches a predetermined temperature.

The invention also provides an injector for injecting fuel into an engine, comprising:
an injector body having a tip, an end region adjacent the tip for storing fuel, and a main body portion in which electrical components for operating the injector are housed;
the end region having an outer surface formed from heat conducting material; and
a heater sleeve arranged on the end region and surrounding the end region, the sleeve including a heater element for receiving electric current to heat the heater element, and therefore conduct heat through the heat conducting outer surface of the end region into the end region of the injector for heating fuel in the end region of the injector so that when the fuel is ejected from the end region the fuel substantially immediately converts to vapor state because of the heating of the fuel and the change in pressure experienced by the fuel when the fuel leaves the injector.

Preferably, the sleeve is formed from a high temperature fuel resistant silicon or viton or like substances in which the heating element is embedded by molding.

Preferably, the heating element comprises a coiled wire. However, in other embodiments, the heating element may be in the form of a semi-cylindrical plate.

Preferably the coiled wire includes a sheath which surrounds the coiled wire to maintain turns of the coiled wire separated from one another when the coiled wire is molded in the sleeve.

Preferably a temperature sensor is disposed adjacent the end region of the injector for monitoring the temperature of the end region of the injector, and therefore the fuel in the end region of the injector.

Preferably the heater sleeve includes a central opening having a peripheral wall for receiving the end region of the injector, and the temperature sensor is arranged between the end region of the injector and the peripheral wall.

The invention may also be said to reside in a fuel delivery system for an engine which has a combustion chamber, a piston moveable in the combustion chamber, an air inlet port, an air inlet port and an exhaust port, comprising:
an injector port in the engine having a first open end communicating with the combustion chamber, and a second end remote from the first end, the injector port having an injector port wall;
a fuel injector located in the injector port, the fuel injector having an injector main body which houses electrical components for operating the injector, an injector tip and an end region adjacent the tip, the end region being for storing fuel to be ejected from the injector;
an electrical heating element for heating the fuel in the end region of the injector;
an electrical current supply for supplying current to the heating element for heating the end region of the injector;
a heat conducting path from the engine to the end region of the injector so the end region of the injector can be heated by heat conducted from the engine;
a current shut-off for shutting off supply of current to the electrical heating element; and
whereupon initial startup of the engine, current is supplied to the electrical heating element to heat the fuel in the end region of the engine, and after initial heating of the fuel in the end region, the current shut-off shuts off current to the engine so the end region is continued to be heated by direct conduction of heat from the engine through the direct conduction path.

Preferably the injector port is located in a manifold connected to the air inlet port and the direct conduction path includes a heat conducting gasket between the inlet port and the manifold for conducting heat to the manifold and then to the end region of the injector.

### BRIEF DESCRIPTION OF THE DRAWINGS

A preferred embodiment of the invention will be described, by way of example, with reference to the accompanying drawings, in which:

FIG. 1 is a view of a fuel delivery system according to one embodiment;

FIG. 2 is a fuel injection system according to a second embodiment;

FIG. 3 is a side view of a gasket used in the embodiments of FIGS. 1 and 2;

FIG. 4 is an end view of the gasket of FIG. 3;

FIG. 5 is a plan view of the gasket of FIGS. 3 and 4;

FIG. 6 is a cross-sectional view through part of a gasket showing in more detail the formation of sealing projections on the gasket;

FIG. 7 is a view of a further embodiment of the invention;

FIG. 8 is a view of a component used in the embodiment of FIG. 7; and

FIG. 9 is a view of a further embodiment of the invention;

FIG. 10 is a side view of a component used in the embodiment of FIG. 9;

FIG. 11 is a plan view of the component of FIG. 10;

FIG. 12 is a side view of a further component used in the embodiment of FIG. 9;

FIG. 13 is a plan view of the component of FIG. 12;

FIG. 14 is a detailed cross-sectional view of an injector in the injector port of an engine according to the embodiment of FIG. 9;

FIG. 15 is a view of an injector according to a still further embodiment;

FIG. 16 is a view of the injector of FIG. 15 installed in an engine;

FIG. 17 is a view of a fuel delivery system according to the preferred embodiment of the invention installed in an engine;

FIG. 18 is a side view of part of the system of FIG. 17;

FIG. 19 is an end view of the part shown in FIG. 18;

FIG. 20 is a view similar to FIG. 18 but showing part of the internal structure of the component of FIG. 18;

FIG. 21 is an enlarged view of the circled part of FIG. 20;

FIG. 22 is a view similar to FIG. 20 of a further embodiment;

FIG. 23 is a cross-sectional view of the embodiment of FIG. 22;

FIG. 24 is a view of a still further embodiment of the invention;

FIG. 25 is an enlarged view of the circled part of FIG. 24;

FIG. 26 is a cross-section view along the line X-X of FIG. 25; and

FIG. 27 is a circuit diagram according to the preferred embodiment of the invention.

### DETAILED DESCRIPTION OF THE PREFERRED EMBODIMENTS

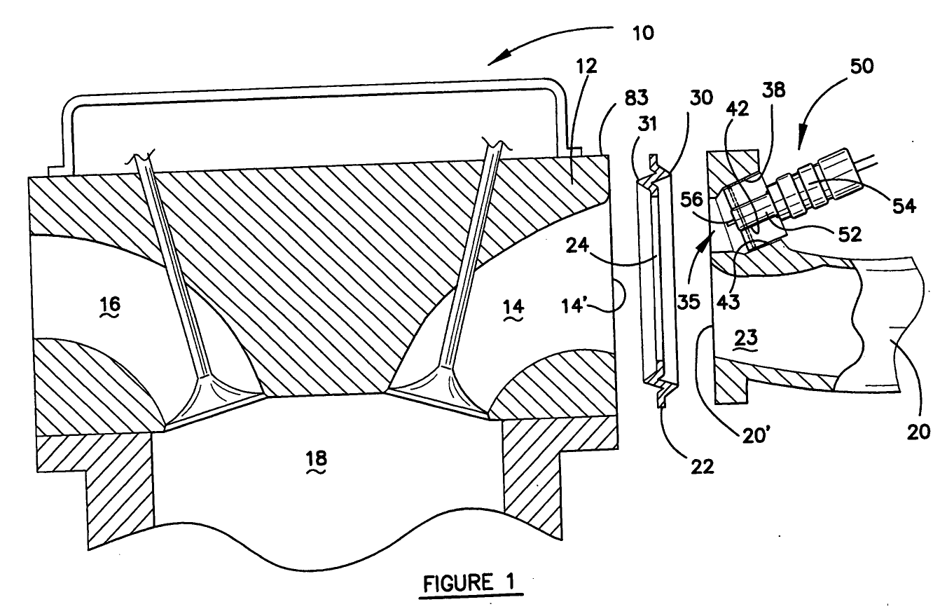

With reference to FIG. 1, a fuel delivery system is shown for an internal combustion engine generally designated 10. The internal combustion engine includes a head 12 which has an inlet port 14 and an exhaust port 16.

A cylinder 18 is provided (and oniy schematically illustrated by the reference numeral 18) in which a piston (not shown) is located for reciprocating movement in the cylinder.

An inlet manifold 20 is connected to the head 12 by bolts (not shown) in the conventional manner. Located between the inlet manifold 20 and the head 12 is a gasket 22. The gasket is formed from heat conducting material such as aluminium or any other suitable metal or heat conducting material.

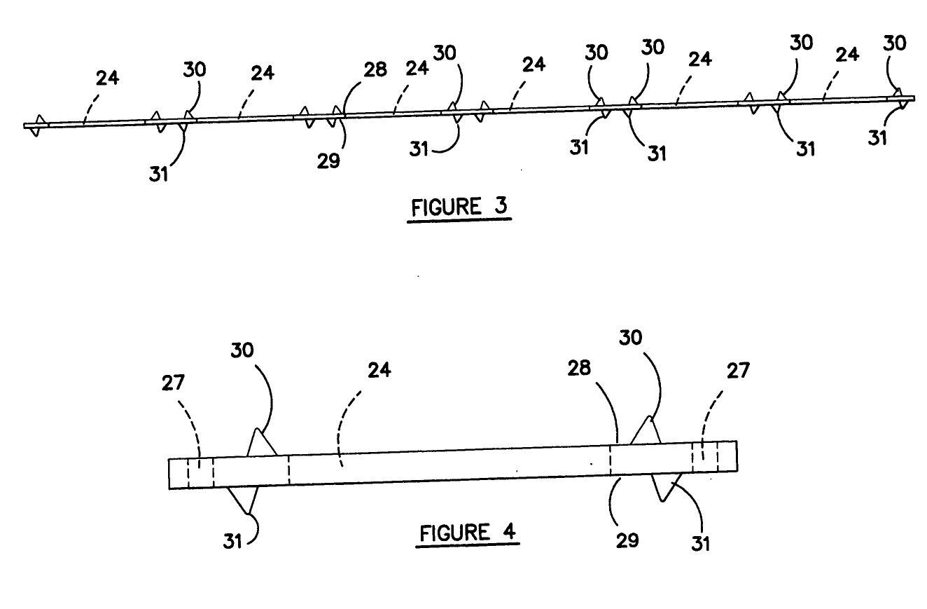

The gasket 22 is shown in more detail in FIGS. 3, 4 and 5. With reference to those figures, the gasket includes a plurality of openings 24. In the embodiments shown, the gasket is intended for a six cylinder in-line engine and has openings 24 corresponding to the six inlet ports 14 of the engine. The gasket 24 has lugs 25 which include holes 27 for receiving bolts (not shown) which are used to secure the manifold 20 to the head 12 and sandwich the gasket between the head 12 and the manifold 20.

The gasket 22 has a first side 28 and a second side 29. Arranged on the sides 28 and 29 are projections 30 and 31 which surround the openings 24.

As is best shown in FIG. 5, the projections 30 (and also the projections 31) are preferably circular in configuration, but the shape will depend on the shape of the opening 24 which may change depending on the configuration of the engine concerned.

The projections 30 and 31 are preferably V-shaped in transverse cross-section, as clearly shown in FIGS. 3 and 4, and when the gasket 22 is sandwiched between the head 12 and the inlet manifold 20, the projections 30 and 31 deform to form a seal around the opening 24 and between the end 14′ of the inlet port 14 and the end 20′ of the inlet manifold 20 so that air passing through the manifold 20 into the inlet port 14 is not able to escape between the inlet manifold 20 and the head 12 of the engine 10.

The inlet manifold 20 is provided with an injection port 35. The injection port 35 shown in FIG. 1 is of standard size, and would normally fit a fuel injector which is provided with seals and an outer casing provided with the injector.

In the first embodiment of the present invention, the injector 50 has its seals and outer casing (neither of which is shown) removed, so as to expose end region 52. The end region 52 is formed from metal. In order to fill the space between the end region 52 and cylinder wall which defines the injector port 35, a collar of heat conducting metal is provided. The collar 40 has a bore 42 which receives the end region 52 in heat conducting contact, and the outer surface 43 of the collar 40 is in heat conducting contact with the wall 38 of the injector port 35.

The injector 50 has a body 54 which contains the electric operating components of the injector, such as the coil, armature, etc. for operating the injector 50 so that fuel can be ejected from the tip 56 of the end region 52.

Thus, according to this embodiment of the invention, heat which is transferred from the cylinder 18 to the head 12 is conducted through the heat conducting gasket 22 to the inlet manifold 20 and, in particular, the end region 23 of the manifold 20 in which the port 35 is formed. Heat is therefore able to conduct through the collar 40 to the end region 52 to heat the end region 52. Thus, the fuel in the end region 52 is elevated in temperature so that, as soon as the fuel leaves the tip 56, the fuel converts to vapour immediately because of the elevated temperature of the fuel and the change in pressure the fuel experiences as soon as the fuel is ejected. Thus, the vapour is then conveyed along the inlet port 14 to the cylinder 18 for combustion in the cylinder 18.

This embodiment of the invention requires no alteration to the usual engine componentry, except for the conducting gasket 22 issues instead of a heat insulating gasket.

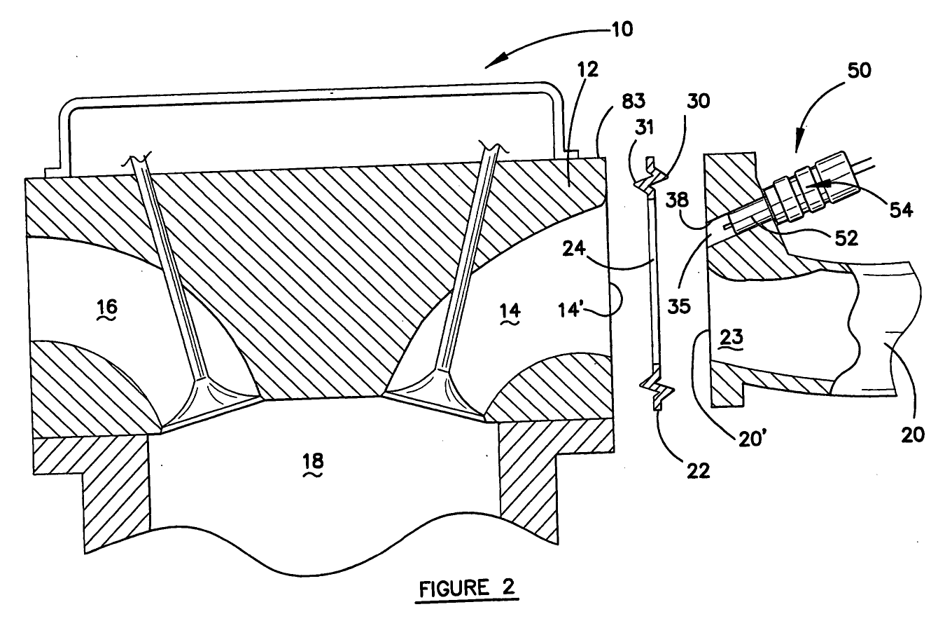

In the embodiment of FIG. 2, the only modification is that the injector port 35 is changed from its standard size shown in FIG. 1 to a much smaller size which matches the size of the end region 52 of the injector 50 after the seal and outer casing of the injector 50 have been removed. Thus, in this embodiment, the collar 40 is not needed and heat is conducted direct from the wall 38 of the injector port 35 to the end region 52.

In both embodiments of the invention, the body 54 is not in heat conducting contact with the engine, and therefore is maintained relatively cool compared to the end region 52 which is in heat conducting contact with the engine via the manifold 20 and the gasket 22. Thus, the body 54 is not heated and therefore, the electronic componentry within the body 54 is not damaged.

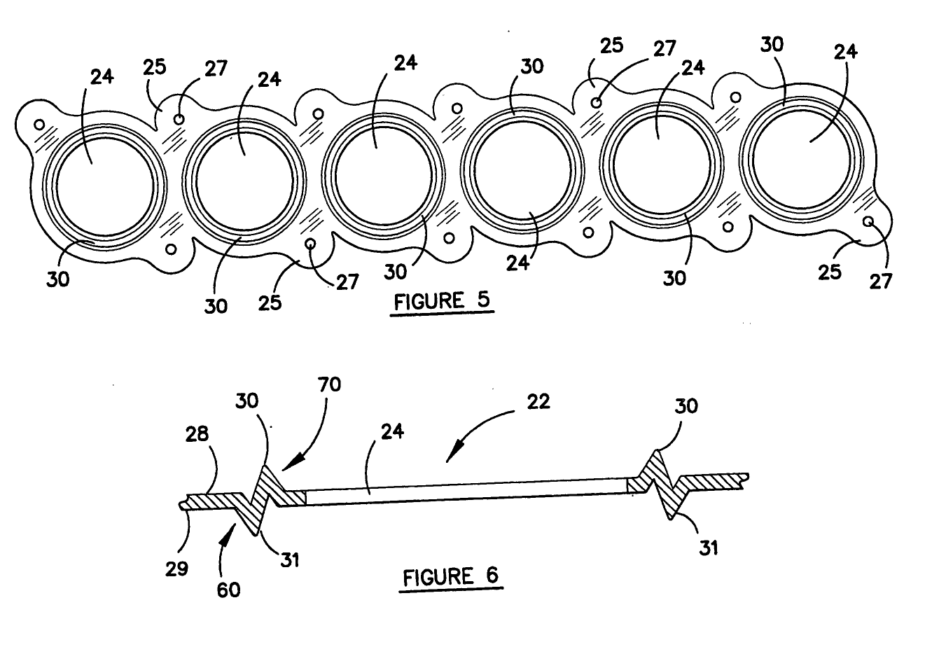

FIG. 6 shows a section of the gasket 22 in more detail and describes how the projections 30 and 31 can be formed. In this embodiment, the gasket 22 is formed by a stamping or pressing operation, and a pressing or stamping tool (not shown) is provided with a zigzagged configuration which presses a V-shaped circular valley 60 around the opening 24, extending from side 29 of the gasket 22 and an upstanding peak 70 also of V-shaped configuration and also surrounding the opening 24. Thus, in this embodiment the projections 30 and 31 are formed by an appropriately bending or deformation of the metal from which the gasket 22 is formed and are offset from one another.

In other embodiments the projections 30 and 31 could be formed in other fashions, including in a moulding operation or otherwise, although such techniques are likely to be more expensive than stamping or pressing the gasket 22.

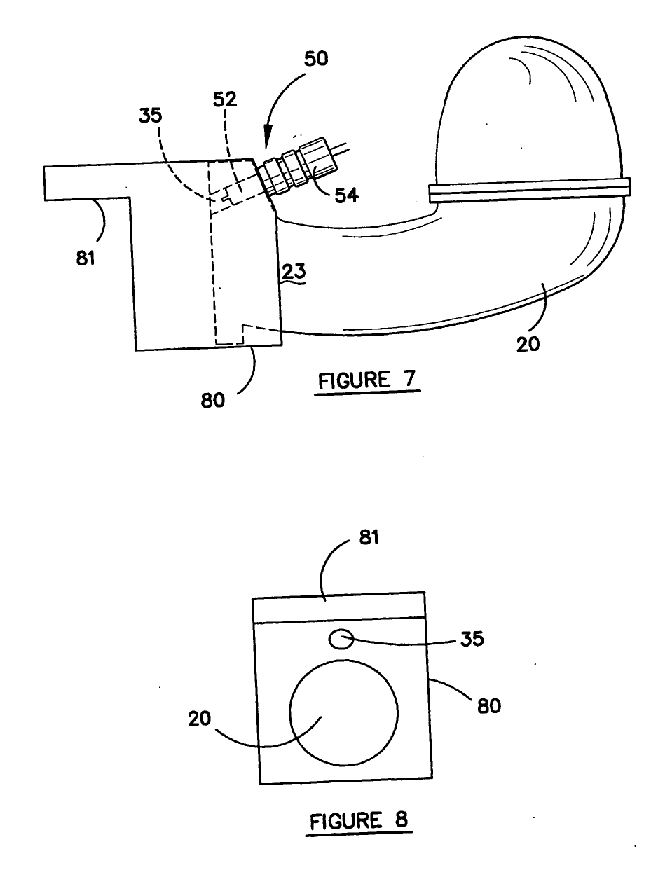

FIGS. 7 and 8 show a further embodiment of the invention. This embodiment is the same as that of FIGS. 1 and 2, except that a housing 80 of insulating material is arranged over the end of the manifold 20 to surround the end of the manifold 20 which is in contact with the end region 52 of the injector 50. This will facilitate retention of heat in that part of the manifold 20, and therefore good heat conduction to the end region 52 of the injector 50. The body 54 is free of the housing 80 and therefore is maintained cool for the reasons specified previously. The housing 80 can be in the form of two halves which simply clip over the manifold 20 and which are supported on the engine head 12 by shelf section 81 locating on shoulder 83 (see FIG. 1) of the head 12.

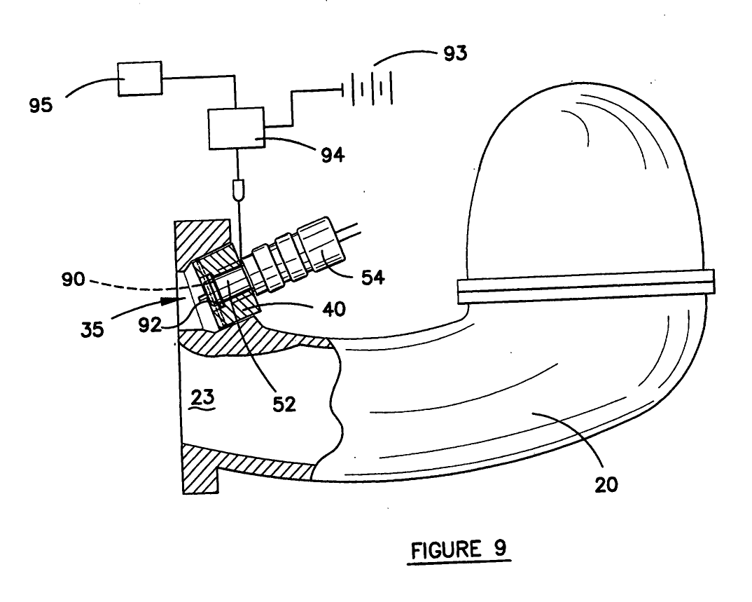

FIG. 9 shows a further embodiment of the invention which is a modification to the embodiment of FIG. 1. In this embodiment like reference numerals indicate like parts to those previously described. For ease of illustration, the gasket 22 and the engine 10 are omitted from FIG. 9.

In this embodiment of the invention, the injector 52 is provided with an electrical heater which comprises a contact pad 90 formed from electrically conductive material, and an insulator 92 which is provided over the pad 90 and insulates the pad 90 from the collar 40 (or if the collar 40 is not used, as in the embodiment of FIG. 2, from the inlet manifold 20). The ring 92 has a step 92a and an internal conical wall 92b. The pad 90 is connected to a battery 93 of the vehicle via a switch 94. A heat sensor 95 for measuring the temperature of the engine in the vicinity of the injector 50 (and in particular, the head of the engine or end region 23 of the manifold 20) is provided for operating the switch 94 to selectively allow current to flow to the pad 90 or to disconnect the flow of current from the pad 90.

As previously mentioned, the pad 90 is in electrical contact with the end region 52, but insulated from the collar 40 and an electric circuit is completed from the pad to earth via the end region 50 to the collar 40 and the manifold 20. Thus, when the switch 94 is switched on, current can flow from the battery 93 to the pad 90 and then through the end region 52 to the collar 40 and manifold 20 (and hence to earth). The insulator 92 prevents current from flowing directly from the pad 90 to the collar 40 without passing through the end region 52. The passage of the current through the end region 52 heats the end region so as to elevate the temperature of the end region during initial engine start-up, so that the end region 52 is heated to the required temperature to cause conversion of the fuel to vapour immediately upon ejection from the injector quicker than the time taken for the engine to heat to the required temperature after initial start-up to conduct sufficient heat to the end region 52 to cause the immediate conversion of fuel to vapour.

Tests have shown that the time taken for the engine to heat to a sufficient temperature to cause the end region to heat to the required temperature can be in the order of 200 seconds. The electrical heating pad increases the heat to the end region by about 1° C. per second, and therefore as soon as the engine is switched on, the switch 94 can be activated so that current is supplied to the end region 52 and the end region will therefore heat to the required temperature much quicker than waiting for sufficient engine temperature to develop for conduction of the required heat to the end region 52. Thus, the vehicle commences to operate with more fuel efficiency more quickly after engine start-up.

The temperature sensor 95 monitors the temperature of the engine, and as soon as the engine reaches the required operating temperature, the temperature sensor 95 can output a signal to cause the switch 94 to switch off so that heat is disconnected from the pad 92. At this time, sufficient heat has been developed for the conduction of heat from the manifold 23 to the end region 52 in the manner previously described to elevate the temperature of the end region 52 to that required to cause the vaporisation of the fuel as soon as the fuel leaves the injector 50.

This embodiment therefore provides the further advantage of providing fuel efficiency more quickly after initial engine start-up.

FIGS. 10 to 14 show the structure of this embodiment in more detail.

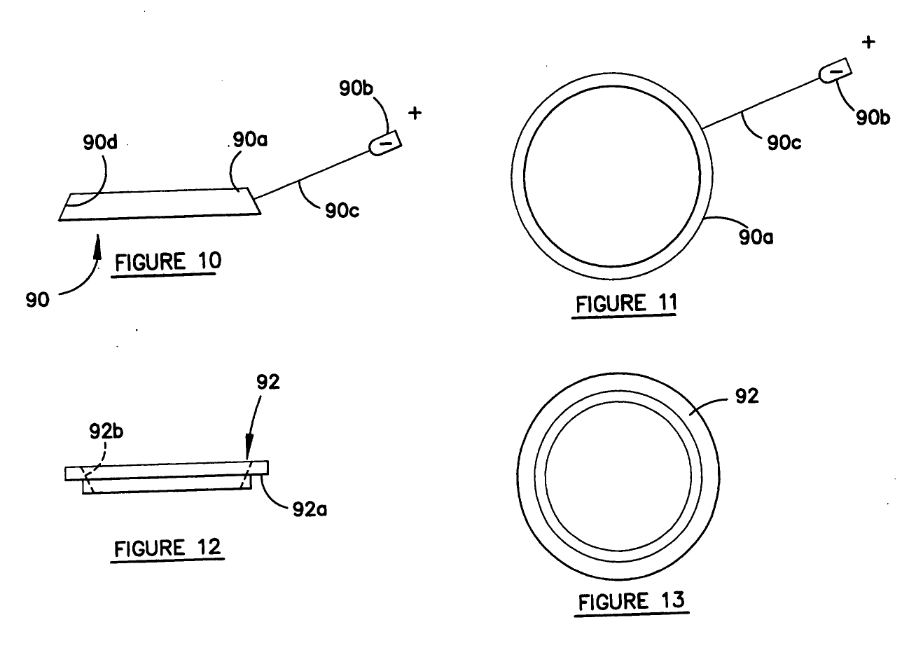

As is shown in FIGS. 10 and 11, the pad 90 comprises a ring 90a of heat conducting metal to which is connected a terminal 90b by a conductor 90c. The ring has an inclined or conical side wall 90d. The conductor 90c is insulated and the terminal 90b connects to a lead (not shown) from the switch 94 so that electric power can be supplied to the terminal 90b, the lead 90c and then to the ring 90a.

FIGS. 12 and 13 show the insulator 92 which is also in the form of a ring formed from any suitable insulating material such as rubber or the like. The ring 92 is a tight fit over the pad 90a to securely hold the pad 90a against the end region 52 of the injector 50, and to insulate the tab 52 from the adjacent part of the collar 40. As shown in FIG. 12, the ring 92 has a step section 92a and an internal conical wall 92b.

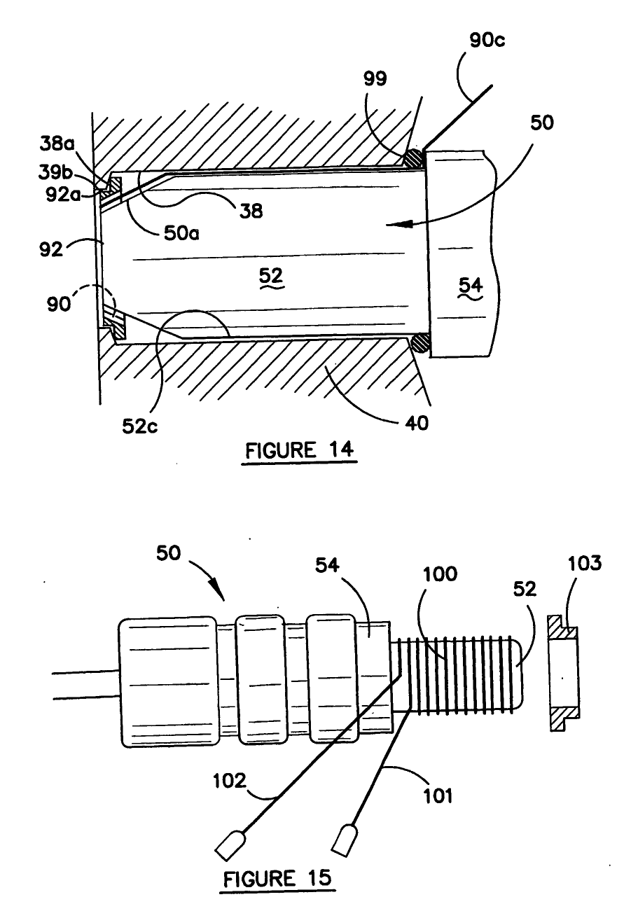

FIG. 14 shows more detail of the actual structure of FIG. 9 and the pad shown in FIGS. 10 and 11 and the insulating ring shown in FIGS. 12 and 13 in an assembled condition. In this embodiment the collar 40 is provided with an internal wall 38 which has an inclined shoulder 38a and a short stem section 39b which defines the opening of the collar 40 which faces the inlet port of the engine.

The end region 52 of the injector 50 is provided with a conical end surface section 50a and the conical wall 90d sits on the conical wall 50a of the injector end region 52. The lead 90c extends between the end region 52 and the wall 38 of the collar 40 and underneath O-ring 99 which can be provided to seal the injector 50 in the collar 40 if desired.

The insulating ring 92 sits over the pad 90 with the internal conical wall 92b rested on the pad 90 and sandwiching the pad 90 between the conical wall 92b and the conical wall 50a of the end region 52. Thus, the pad 90 is pushed into electrically conducting contact with the end region 52.

The inclined wall 38a and the stem 39b register in step 92a to facilitate location of the injector 50 and also holding of the injector 50 in the collar 40. The external wall 52c of the end region 50 is therefore in contact with the internal wall 38 of the collar 40, although, for illustrative reasons in FIG. 14, a slight space can be seen. Thus, heat is still able to conduct from the collar 40 to the end region 52 in the manner described in the earlier embodiment.

Thus, as is previously described, heat can initially be applied by the pad 90 to the end region 52 to heat the end region, and when the engine warms to the required temperature, heat is conducted via the collar 40 to the end region 52 in the manner described in the previous embodiment.

FIG. 15 shows a second embodiment of the invention. In this embodiment the injector 50 is provided with an electrically insulated heating coil 100 which is wound all the way along the end region 52. The coil 100 has ends which are connected to conductors 101 and 102 which are connected to the positive terminal of the vehicle battery and to earth respectively. Electric current is supplied to the coil 100 which heats up due to the flow of current through the coil 100, and in turn heats the end region 52. Thus, the end region 52 is elevated to the required temperature to cause the fuel to immediately convert to vapour upon ejection from the injector 50.

In this embodiment, a seal 103 may be provided so as to slightly space the coil 100 from the collar 40 or the internal wall 38 of the injector port 35 (as the case may be). In this embodiment all of the heat for supply to the end region 52 is provided by the heating coil 100 rather than heat conduction from the engine. Thus, in this embodiment the gasket between the manifold 20 and the engine 10 can be the conventional insulating gasket.

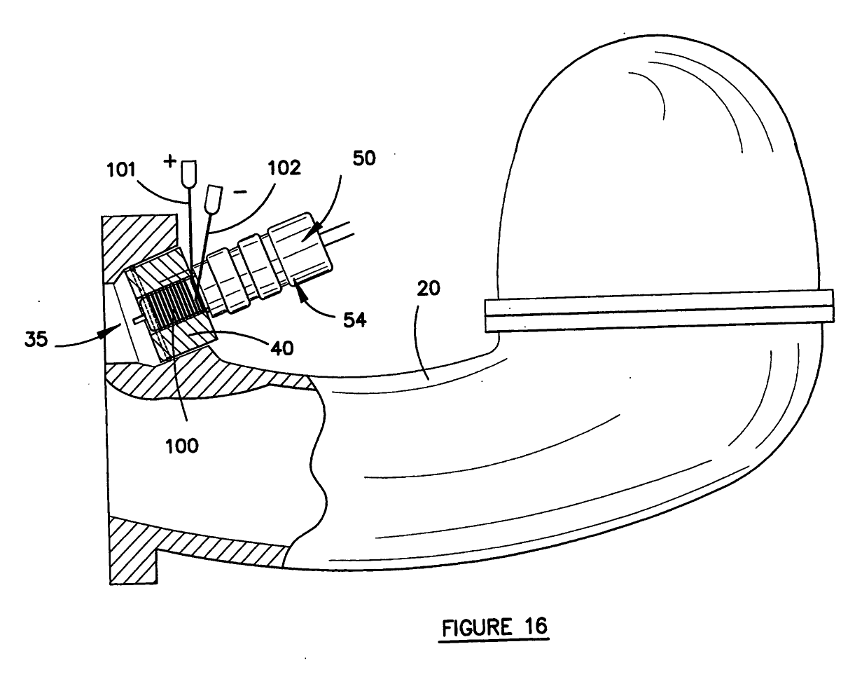

FIG. 16 shows the injector of FIG. 15 located in the engine in the arrangement in which a collar 40 is used. This embodiment is also applicable to the situation of FIG. 2 in which the injector port 35 is drilled to match the size of the end region 52 having the coil 100. Thus, in this alternative arrangement, injector port 35 can be drilled to a smaller size to match the diameter of the end region 52 with the coil 100, and again, if desired, the coil can be slightly spaced from the wall of the port 35 by a seal similar to the seal 103 shown in FIG. 15.

As in the previous embodiments, the electrical heating element provided by the pad 90 or the coil 100, heats only the end region 52 of the injector 50 and not the body 54. Thus, the body 54 is not elevated in temperature and remains in the free air where it is cool, and therefore the heat supplied by the electrical heating system of FIGS. 9 to 14 or Figures and 16 does not detrimentally effect operation of electronic components within the body 54.

Embodiments of the invention which use the electrical heating system of FIGS. 9 to 16 are most suitable for vehicles which have relatively high voltage electrical supply, such as 24 volt operation so that the current drawn does not create too great a load on the engine, and therefore defeat the purpose of heating the end region. If the current drawn increases the load on the engine to too great an extent, the engine will require a greater amount of fuel to operate at the same level as without the electrical system.

The present invention enables fuel savings and therefore greater economy because the amount of fuel which is required can be decreased. This is performed by ensuring that the injector injects a smaller quantity of fuel each time the injector is opened. However, if it is desired to provide greater performance, such as in the case in a racing car or the like, then the present invention, because of the complete vaporisation of all the fuel ejected by the injector, can allow the injector to be operated such that a larger amount of fuel is provided each time the injector is opened. Because of the vaporisation of the fuel, the additional fuel imputed into the engine will not adversely affect the spark from the spark plug of the engine, which is the case if an attempt is made to increase the delivery of liquid fuel to the engine, and which therefore may result in the greater volume of fuel putting out the spark and causing a misfire. Thus, greater performance can be achieved in racing environments or the like by the addition of more fuel so that greater power from each combustion in the combustion chamber is achieved.

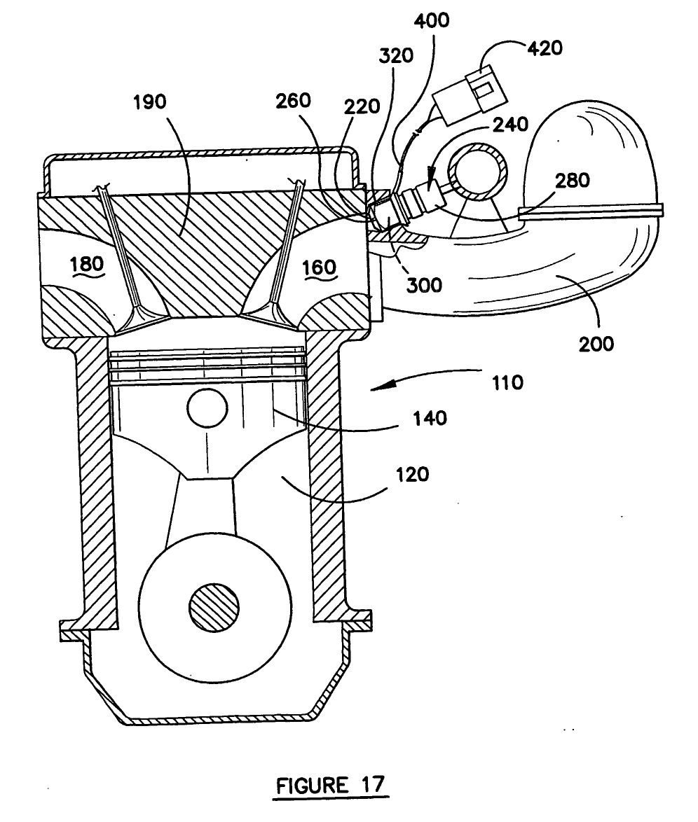

With reference to FIG. 17, an engine 110 is shown which has a cylinder 120 in which a piston 140 is mounted. The engine 110 has an inlet port 160 and an exhaust port 180. An inlet manifold 200 is connected to the inlet port 160.

An injector port 220 is arranged in the inlet manifold 200 for receiving a fuel injector 240 so fuel can be injected into the inlet port 160 and conveyed to the cylinder 120 with inlet air.

The injector 240 is a standard fuel injector which has a tip 260, a main body portion 280 and end region 300 adjacent the tip 260. The main body 280 contains the electrical componentry for operating the injector in accordance with control from the engine ECU (not shown). The end region 300 stores fuel to be ejected from the injector. The injector 240 is modified only by removing the outer casing around the end region 300 so as to leave the metal peripheral wall of the end region 300 exposed. A heater sleeve 320 is provided on the end region 300 and is dimensioned so that the sleeve 320 together with the injector 240 fits into the existing injector port 220 without any modification. The sleeve 320 also performs a function of a seal to seal the injector 240 in the port 220.

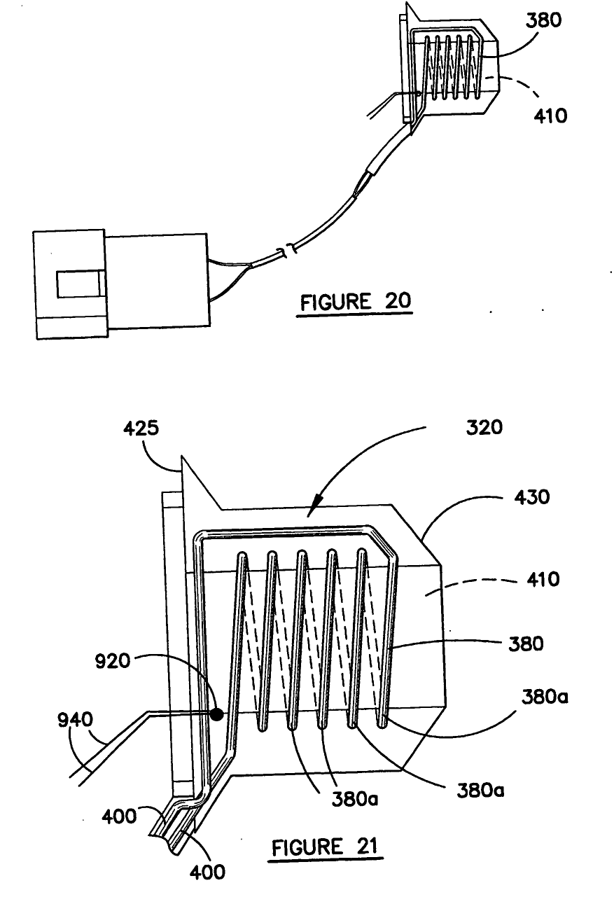

The sleeve 320 carries an electric heating element 380 (see FIGS. 20 and 21), and current is supplied to the element 380 by conductors 400. The conductors 400 are connected to a connector 420 which in turn connects to an electrical system (not shown in FIG. 17) for supplying electric power to the heating element 380 so the heating element is heated to in turn heat the end region 300 of the injector 240 and the fuel which is contained in the end region, but does not heat the main body portion 280 in which the electrical componentry is contained. Thus, as in the earlier International application previously mentioned, the end region of the injector 300 is heated to in turn heat the fuel in the end region so that when the fuel is ejected from the tip 260, the fuel substantially immediately converts to vapor because of the heating of the fuel and the change in pressure experienced by the fuel when the fuel leaves the injector and enters the port 220 and inlet port 160.

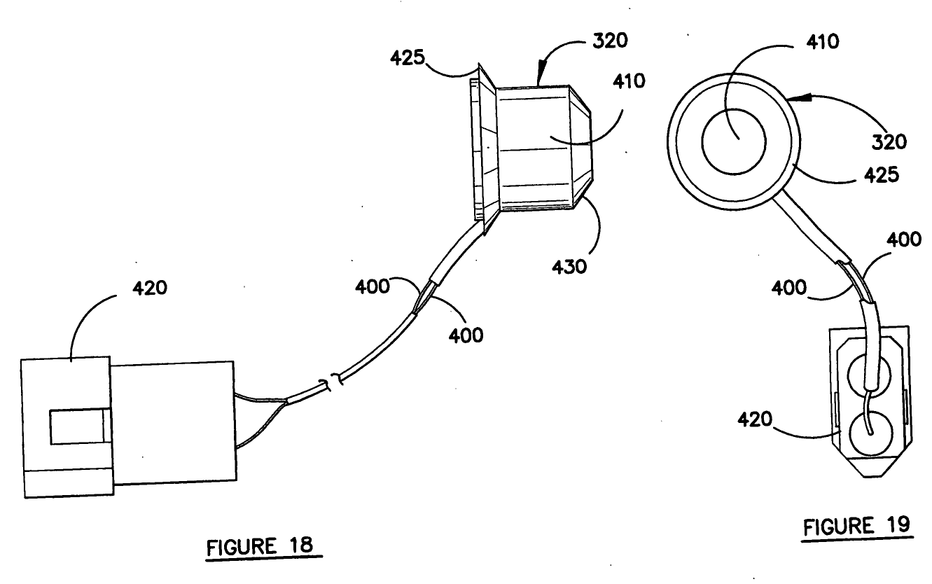

FIGS. 18 and 19 are a more detailed view of the sleeve 240. As is apparent from FIGS. 18 and 19, the sleeve 240 is a generally cylindrical body having a central opening 410 in which end region 300 is received, a tapered front 430 and a rear flange 425. The heating element 380 may comprise a coil of wire which is molded and embedded in the sleeve 320 and conductors 400 are a continuation of the coil within the sleeve 320 and joined to connector 420 as previously mentioned.

FIG. 20 is a view which shows the coil 380 in more detail, as does the enlarged view of FIG. 21. As is apparent from FIGS. 20 and 21, the coil which forms the heating element 380 comprises a number of turns 380a which are spaced apart from one another so the turns do not touch and join with the conductors 400 so current can be supplied to the heating coil 380 to heat the heating coil. FIGS. 20 and 21 also show the central cavity or bore 410 in which the end region 300 of the injector 240 locates.

In the preferred embodiment of the invention, the heating element 380 is formed from nicane wire which offers a resistance to the current supplied by the conductors 400, thereby heating up the heating coil 380 as current travels through the coil 380. The heater sleeve 320 is preferably formed from a high temperature silicon which is heat conducting so that heat generated by the coil 380 is conducted through the sleeve 320 to the end region 300 of the injector 240. In other embodiments, the sleeve 320 could be formed from other materials such as high temperature plastics, ceramics, and the like.

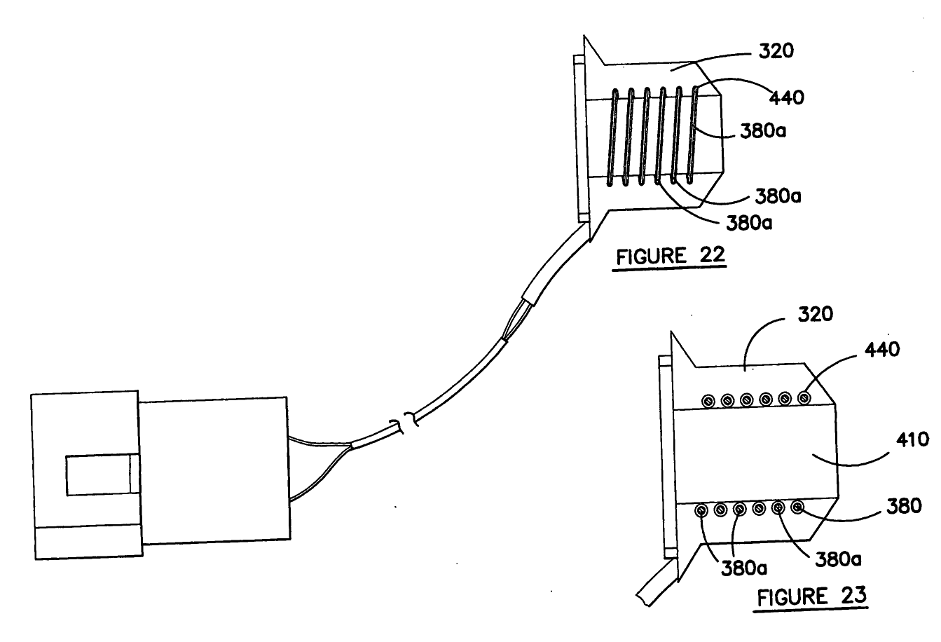

FIGS. 22 and 23 show a second arrangement in which the turns 380a are contained within a sheath 440. The sheath 440 prevents the wire turns 380a from coming into contact with one another, should the turns 380a be pushed slightly during the molding of the sleeve 320, and therefore prevents short circuiting within the coil 380 which would impair the operation and heat efficiency of the heating sleeve 320. The sheath 440 therefore makes molding easier because it is not necessary to ensure that the turns 380a remain apart from one another, and therefore may avoid the need for an inner mandrill or sleeve on which the turns 380a are mounted when the coil 380 is located in a mold for molding of the sleeve 320.

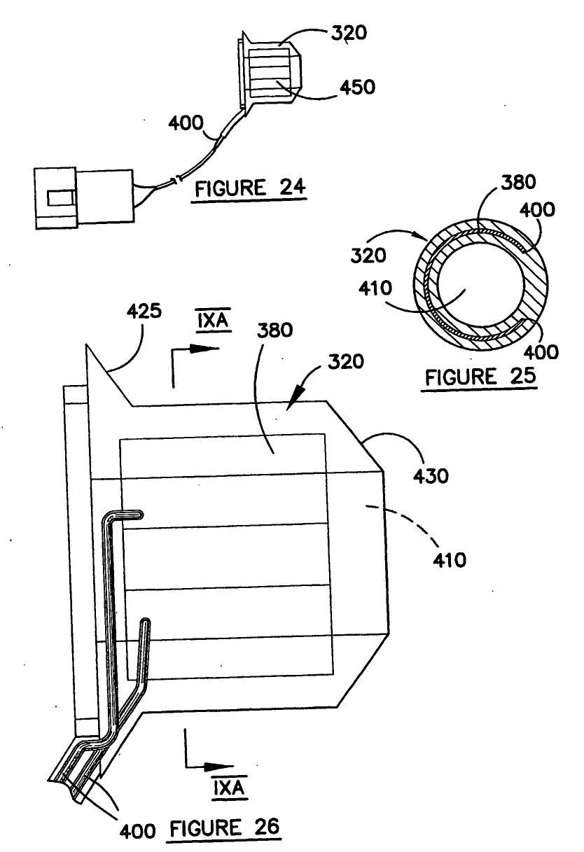

FIGS. 24 and 25 show a further embodiment of the invention in which the heating element 380 is in the form of a C-shaped band, as best seen in the cross-sectional view of FIG. 26. Thus, the preferred embodiment of the invention enables a conventional injector to be used save for the need to remove the outer casing surrounding the end region 300, and also avoids the need to use separate seals to seal the injector in the injector port 220. The sleeve 320 performs the function of locating the injector 240 in the port 220 and also sealing the injector in the port, as well as heating the end region 300, as described above.

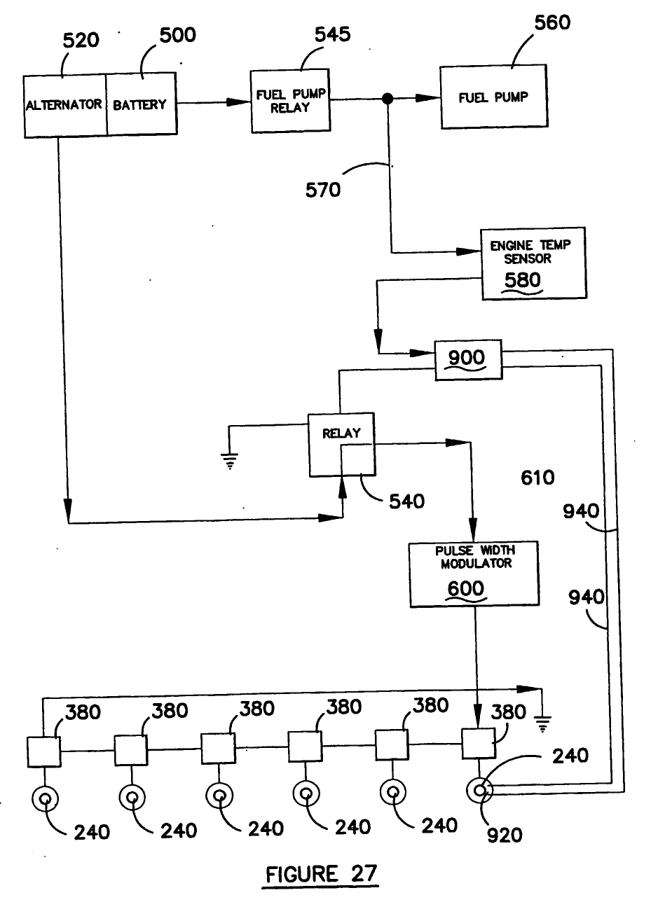

FIG. 27 is a block circuit diagram showing operation of the preferred embodiment of the invention. The circuit includes a battery 500 and alternator 520 which supply current to a relay 540. The battery also supplies power to a fuel pump relay 545 and then to a fuel pump 560, as is conventional. The relay 540 is tapped into the circuit between the fuel pump relay 545 and fuel pump 560 by line 570, as shown in FIG. 27. Thus, when the vehicle engine is initially turned over by starting the engine, the fuel pump relay is closed so that power is supplied to the fuel pump. Immediately on starting of the engine, power is therefore supplied on line 570. The line 570 includes an engine temperature sensor 580 which monitors the temperature of the engine, and if the temperature is below a predetermined temperature, the engine temperature sensor supplies the current on line 570 to the relay 540, which causes the relay 540 to close.

When the relay 540 is closed, current is supplied from the alternator 520 to the heating element 380 of the injector 240.

FIG. 26 shows six injectors 240, each with their own heating 380 arranged in series. However, it should be understood that different configurations could be used, such as some of the injectors 240 could be wired in series, and some parallel or all could be wired in parallel, depending on the application, the number of cylinders, and therefore the number of injectors required, and the voltage capacity of the barratry which powers the vehicle.

In the preferred embodiment of the invention, a pulse width modulator 600 is also located in the line 610 between the relay 540 and the injectors 240 so that a pulse width signal is supplied to the elements 380. The pulse width modulator 600 may be controlled to alter the pulse width or duty cycle of the signal supplied to the elements 380 to control the degree of heating of the elements 380 in accordance with the requirements of the engine during operation. Thus, the pulse width modulator 600 can be used to maintain a constant temperature output by the heating elements 380 with reduced power requirements. The pulse width modulator 600 will also draw approximately half the power requirements than embodiments without the pulse width modulator because of the modulation of the signals supplied to the heating elements 380.

The pulse width modulator 600 also enables a smaller heating element to be used in the sleeve 320. The reason for this is that if the heating element 380 is continuously heated by usual battery supply power, the heating element can easily overheat. Thus, in order to ensure this does not happen, the heating element needs to be relatively large diameter and also relatively long. This creates problems because of the relatively small size of the sleeve 380. By using the pulse width modulator which reduces the amount of current which is supplied to the heating element, the length of the heating element 380 and the wire diameter or wire gauge can be made smaller.

When the engine temperature reaches a predetermined temperature, the sensor 580 can shut off power supply to the relay 540, thereby causing the relay 540 to open and shut off current to the heating elements 380.

In another embodiment of the invention, rather than rely on the engine temperature sensor 580 to switch the relay on and off, a further temperature sensor switch 900 can be incorporated in the line 570. This switch may be used in combination with the engine temperature sensor 580, or instead of the engine temperature sensor 580. The switch 900 is connected to a heat sensing probe 920 which is located in the sleeve 320 between the end region 300 of the injector 240 and the peripheral wall of the central opening 410 of the sleeve 320. The sensor 920 may be in the form of a thermo-couple and connected to the switch by lines 940. Thus, the temperature sensor 920 more accurately detects the actual fuel temperature within the end region 300 so that when the temperature does reach the required level, the switch 900 can be opened so that power is disconnected to the relay 540, thereby causing the relay 540 to open so power is not supplied from the battery 500 to the heating elements 380. If the temperature of the fuel decreases below a predetermined value, the switch 900 can be closed so the heating element 380 is again energised to heat the end region 300 of the injector.

Preferably the temperature of the fuel in the end region 300 is in the range of about 80 to 92° C., and therefore the use of the temperature sensor 920 in close proximity to the end region 300 provides a better measure of the temperature of the fuel, and therefore a better indication of when the electrical heating element 380 can be switched off.

The sleeves 320, as is previously described, are heat conductive so that heat is conducted from the hot engine through the sleeve 320 and to the end region 300 of the injector 400, so the end region is heated by direct heat from the engine rather than heat from the heating element 380. Thus, the manifold 200 may be connected to cylinder block 190 of the engine 100 by a heat conducting gasket (not shown) so that heat is conducted from the cylinder block 190 to the inlet manifold 200 surrounding the port 220 so heat is in turn conducted through to the end region 300 in the same manner as disclosed in the above-mentioned provisional application.

Thus, when the temperature sensor 920 indicates that the heating element 380 has heated the fuel in the end region 300 to the required temperature, the heating element 380 can be switched off by the switch 900 and maintenance of the required heat is maintained by conduction from the engine to the sleeve 320, and then to the end region 300. If for any reason the temperature of the fuel does drop below the predetermined level, the switch 900 can close to supply power to the relay 540 to again energise the heating element 380.

As shown in FIG. 27, only one of the injectors 240 is shown with the temperature sensor 920. However, all of the injectors 240 can be provided with the temperature sensor 920 and connected to the switch 900, and the relay and pulse width modulator could be arranged so that independent power supplies can be supplied to each of the heating elements 380 so that each injector is separately monitored for temperature of the fuel in the end region, and separately heated by its respective heating element 380 when needed.

Thus, the preferred embodiment of the invention has the advantage that heat is instantly applied to the end region 300 of the injector as soon as the engine is started. Tests have shown that the end region 300 can be heated in approximately 20-40 seconds or less to bring the fuel in the end region 300 up to the required temperature, whereas if engine temperature is required, it may take approximately 5 to 15 minutes for the engine to heat sufficiently so that the fuel in the end region 300 is brought to the required temperature.

The circuitry shown in FIG. 27 may be formed as part of the engine operating loom, or if the system is added to an existing vehicle, may be provided in its own loom or as a separate wiring system.

Whilst the temperature sensor 580 can switch off the relay 540 when the operating temperature of the engine reaches a predetermined temperature, the sensor 580 could be controlled to power the relay 540 or the relay 540 could otherwise be powered to close the relay in other operating conditions, such as when higher engine loads exist and more fuel is required, so that the additional fuel is adequately and quickly heated by the heating element 380, as well as conducted heat from the engine 1000.

Thus, the preferred embodiment of the invention can be provided as a retrofit system for existing engines, or it could be provided as original equipment. If provided as an original equipment, the control of the heating element 380 can be performed in accordance with the above description by the engine electronic control unit (not shown) of the vehicle. Thus, the injectors 24 will be coupled to the ECU as is usual, and the ECU could be programmed so as to monitor the temperature signal from the sensors 920 and switch the power to the heating elements 380 when needed (ie. at startup of the engine) and if the fuel temperature in the end region 300 drops during normal operation. Thus, the injector would be provided with the sleeve 320 as original equipment and the electrical supply to the injector would be the normal pulse supply from the ECU to control the fuel ejection from the injector, the heating conductors 400 for the supply of electricity to the heating element 380, and the lines 940 for the temperature measurement from the sensor 920.

The sensor 920 may be sandwiched tightly between the end region 300 and the inner wall of the central opening 410, or may be provided just in the inner wall 410 in a groove or recess of the inner wall so the temperature sensor 920 still abuts the end region 300 for temperature measurements.

Since modifications within the spirit and scope of the invention may readily be effected by persons skilled within the art, it is to be understood that this invention is not limited to the particular embodiment described by way of example hereinabove.

1. A fuel delivery system for a vehicle engine, having at least one cylinder, a piston moveable in the cylinder, and an inlet port for supplying air and fuel to the cylinder, comprising:
an inlet manifold for supplying air to the inlet port;
a heat conducting gasket between the engine and the inlet manifold;
an injector port in the inlet manifold;
a fuel injector having an end region and a body, the body including componentry for operating the injector, the injector being located in the injector port; and
wherein heat is conducted from the engine via the heat conducting gasket to the inlet manifold, and then to the end region to heat the end region, but not the body of the injector, to elevate the temperature of fuel in the end region, so that when the fuel is ejected from the end region of the injector, the fuel substantially immediately converts to vapour because of the heating of the end region and therefore the fuel in the end region, and the change in pressure experienced by the fuel as the fuel leaves the end region of the injector.

2. The system of claim 1 wherein a heat conducting collar is provided around the end region of the injector and in heat conducting contact with the end region, and the collar being in the heat conducting contact with a wall defining the injector port.

3. The system of claim 2 wherein the injector port is sized such that the end region of the injector is in direct heat conducting contact with a wall defining the injector port.

4. The system of claim 1 wherein the gasket includes opposed sides, and at least one opening for providing communication from the inlet manifold to the inlet port, a first raised section surrounding the opening on one side of the gasket, and a second raised section surrounding the opening on the other side of the gasket, so that when the gasket is located between the engine and the inlet manifold, and the inlet manifold secured to the engine, the raised sections deform to form a seal about the opening.

5. The system of claim 4 wherein the gasket is formed in a stamping or pressing operation, and the raised section is formed by a V-shaped projection in transverse cross-section on one side of the gasket, and an offset V-shaped projection in transverse cross-section on the other side of the gasket.

6. The system of claim 1 wherein a housing is provided for locating over the injector and the injector port to facilitate the retention of heat to heat the end region of the injector.

7. The system of claim 1 wherein electrical heating means is provided for supplying heat to the end region during initial start-up of the engine before the engine acquires sufficient heat for conduction to the end region to heat the end region, and therefore the fuel in the end region by heat conducted from the engine.

8. The system of claim 7 wherein the electrical heating means comprises an electrical heating pad in electrical contact with the end region, an insulating member between the pad and the engine, and an electrical inductor in electrical communication with the pad so that current is supplied to the pad and then flows through the end region to heat the end region.

9. The system of claim 7 wherein the electrical heating means comprises a coil wound around the end region, electric leads for supplying current to the coil so that the passage of current through the coil generates heat to the heat the end region.

10. The system of claim 1 wherein the system includes temperature sensing means for monitoring the temperature of the engine in the vicinity of the fuel injector for switching off the electrical heating means when the engine temperature reaches a predetermined temperature whereby sufficient heat is conducted from the engine to the end region to heat the fuel in the end region.

11. A fuel injector for an internal combustion engine having a piston moveable in a cylinder, the injector comprising:
an end region;
a body;
electrical componentry in the body operable to enable fuel to be ejected from the end region of the injector;
electrical heating means on the external surface of the end region for heating the end region of the injector, but not the body, so that when fuel is located in the injector and the electrical heating means operated, the fuel is ejected from the end region of the injector and substantially immediately converts to vapour because of the heating of the end region and therefore the fuel in the end region, and the change in pressure experienced by the fuel as the fuel leaves the end region of the injector; and
wherein the electrical heating means comprises an electrical heating pad in electrical contact with the end region, an insulating member between the pad and the engine, and an insulated electrical conductor in electrical communication with the pad so that current is supplied to the pad and then flows through the end region to heat the end region.

12. The system of claim 11 wherein the electrical heating means comprises an insulated heating coil wound around the end region, and electrical conductors for supplying current to the coil so that the passage of current through the coil generates heat to heat the end region.

13. A fuel delivery system for an engine which has a combustion chamber, a piston movable in the combustion chamber, an air inlet port and an exhaust port, comprising:
an injector port in the engine having a first open end communicating with the combustion chamber, and a second end remote from the first end, the injector port having an injector port wall;
a fuel injector located in the injector port, the fuel injector having an injector main body which houses electrical components for operating of the injector, an injection tip and an end region adjacent the tip, the end region being for storing fuel to be ejected from the injector;
an electrical heating element surrounding the end region exterior of the fuel injector;
an electric current supply for supplying current to the heating element for heating the end region of the injector to in turn heat the fuel in the end region so that when the fuel leaves the injector, the fuel substantially immediately converts to vapor because of the heating of the fuel and the change in pressure experienced by the fuel when the fuel leaves the injector; and
wherein the current supply device comprises a battery for supplying current and a pulse width modulator for modulating the current supplied by the battery so that the current supplied to the heating element is pulsed width modulated so that the amount of current supplied to the heating element can be controlled to thereby control the heating of the heating element, and therefore the heating of the fuel within the injector end region.

14. The system of claim 13 wherein the heating element is provided in a cylindrical sleeve which locates over the end region of the injector, and sits between the end region of the injector and the injector port wall of the injector port in the engine.

15. The system of claim 13 wherein the current supply comprises at least one conductor extending from the heating element to a current supply device.

16. The system of claim 13 wherein the current supply includes a relay so that current is supplied when the relay is closed, and a control current supply for closing the relay.

17. The system of claim 16 wherein the control current supply comprises a signal from a fuel pump relay which passes through an engine temperature sensor so that if the engine temperature is below a predetermined temperature, the relay is closed to thereby enable current to be supplied to the heating element.

18. The system of claim 17 wherein the fuel injector includes a temperature sensor for monitoring the temperature of the fuel in the end region and for opening the relay when the temperature reaches a predetermined temperature.

19. An injector for injecting fuel into an engine, comprising:
an injector body having a tip, an end region adjacent the tip for storing fuel, and a main body portion in which electrical components for operating the injector are housed;
the end region having an outer surface formed from heat conducting material;
a heater sleeve arranged on the end region and surrounding the end region, the sleeve including a heater element for receiving electric current to heat the heater element, and therefore conduct heat through the heat conducting outer surface of the end region into the end region of the injector for heating fuel in the end region of the injector so that when the fuel is ejected from the end region the fuel substantially immediately converts to vapor state because of the heating of the fuel and the change in pressure experienced by the fuel when the fuel leaves the injector; and
wherein the sleeve is formed from a high temperature silicon in which the heating element is embedded by molding, the sleeve forming a heat conducting path for conducting heat from the engine through the sleeve to the end region of the injector.

20. The injector of claim 19 wherein the heating element comprises a coiled wire.

21. The injector of claim 20 wherein the coiled wire includes a sheath which surrounds the coiled wire to maintain turns of the coiled wire separated from one another when the coiled wire is molded in the sleeve.

22. The injector of claim 19 wherein a temperature sensor is disposed adjacent the end region of the injector for monitoring the temperature of the end region of the injector, and therefore the fuel in the end region of the injector.

23. The injector of claim 19 wherein the heater sleeve includes a central opening having a peripheral wall receiving the end region of the injector, and the temperature sensor is arranged between the end region of the injector and the peripheral wall.

24. A fuel delivery system for an engine which has a combustion chamber, a piston moveable in the combustion chamber, an air inlet port, an air inlet port and an exhaust port, comprising:
an injector port in the engine having a first open end communicating with the combustion chamber, and a second end remote from the first end, the injector port having an injector port wall;
a fuel injector located in the injector port, the fuel injector having an injector main body which houses electrical components for operating the injector, an injector tip and an end region adjacent the tip, the end region being for storing fuel to be ejected from the injector;
an electrical heating element for heating the fuel in the end region of the injector;
an electrical current supply for supplying current to the heating element for heating the end region of the injector;
a heat conducting path from the engine to the end region of the injector so the end region of the injector can be heated by heat conducted from the engine;
a current shut-off for shutting off supply of current to the electrical heating element; and
whereupon initial startup of the engine, current is supplied to the electrical heating element to heat the fuel in the end region of the engine, and after initial heating of the fuel in the end region, the current shut-off shuts off current to the engine so the end region is continued to be heated by direct conduction of heat from the engine through the direct conduction path.

25. The system of claim 24 wherein the injector port is located in a manifold connected to the air inlet port and the direct conduction path includes a heat conducting gasket between the inlet port and the manifold for conducting heat to the manifold and then to the end region of the injector.
